(19) United States
(12) Patent Application Publication
(10) Pub. No.: US 2011/0080383 A1
(43) Pub. Date: Apr. 7, 2011

(54) Display panel with optimum pad layout of the gate driver

(76) Inventors: Wen-Chiang Huang, Hsin-Chu (TW); Sheng-Kai Hsu, Hsin-Chu (TW)

(21) Appl. No.: 12/880,152

(22) Filed: Sep. 12, 2010

(30) Foreign Application Priority Data
Oct. 6, 2009 (TW) 098133841

(51) Int. Cl. G06F 3/038

(52) U.S. Cl. 345/204

(57) ABSTRACT

A display panel includes a display area, a first bonding area, and a second bonding area. The second bonding area is used for bonding with a gate driver. The second bonding area includes a plurality of input pads and a plurality of output pads. The plurality of input pads is disposed on the two sides of the second bonding area in the first direction and on the two sides of the second bonding area only the plurality of input pads is disposed in the second direction. The plurality of output pads is disposed on the center region of the second bonding area in the first direction and on the center region of the second bonding area only the plurality of output pads is disposed in the second direction.

### BACKGROUND OF THE INVENTION

1. Field of the Invention

The present invention is related to a display panel, and more particularly, to a display panel with optimum pad layout of the gate driver.

2. Description of the Prior Art

Please refer to FIG. 1. FIG. 1 is a diagram illustrating a conventional liquid crystal display (LCD) 10. The LCD 10 comprises a display panel 11, a printed circuit board (PCB) 12, a plurality of flexible printed circuit boards (FPC) 13, and a plurality of gate drivers 15. Generally speaking, the display panel 11 and the printed circuit board 12 are bonded by the technology of tape automated bonding (TAB) or chip on glass (COG). Comparing with TAB, the amounts of the FPCs 13 and the PCB 12 used by COG are less. For further reducing the number of the layers of the FPCs 13 and the PCB 12, the products of COG usually use the method of wiring on array (WOA) for cascading the drivers.

In the cascaded drivers, as long as the first driver transmits the data and the control signals, the other drivers can receive the data and the control signals. The FPCs 13 connected to the display panel 11 have to provide the data and the control signals to the first driver and provide the power signal to each driver, but the FPCs 13 do not have to provide the data and the control signals to each driver, which is different from the general method of respectively transmitting the data and the to each driver. Therefore, the amount of the wires and the circuit area of the FPCs 13 can be reduced. The drivers are cascaded by the wires on the glass substrate, so that the design of the PCB 12 is simplified and the number of the layers of the PCB 12 is reduced. Since the number of the signals of the gate driver 15 is small so that the number of the junction points of the gate driver 15 is small, the surrounding wires and the pad layout of the display panel 11 are easier for cascading designation. On the other hand, since number of the signals of the source driver 14 is large, the layout of the display panel 11 is limited by the chip size, reducing the design flexibility.

Please refer to FIG. 2. FIG. 2 is a diagram illustrating the pad layout for bonding with the gate driver. The pad layout 20 corresponding to the gate driver 15 comprises a plurality of output pads 22 and a plurality of input pads 241, 242, and 243. The pad layout 20 represents the pads required for bonding a gate driver 15 to the display panel 11. Relatively, the gate driver 15 has the corresponding pins as well. As shown in FIG. 2. The output pads 22 are disposed on the upper side of the center region of the gate driver 15. The input pads 241, 242 are disposed on the left side and the right side of the gate driver 15. The input pads 243 are disposed on the down side of the center region of the gate driver 15. Generally speaking, the pad layout 20 of the gate driver 15 has to dispose the pads evenly surrounding the gate driver 15 for improving the yield of the junction fabrication. Therefore, in the pad layout 20, the pads of the upper side and the pads of the down side of the gate driver 15 are distributed as evenly as possible. That is, the area ratio of the output pads 22 to the input pads 243 are designed to be around 1:1. However, in this way, the size of the gate driver is limited as well.

In conclusion, the pad layout of the gate driver is a main factor for the size of the gate driver. Because of the mature VLSI technology, it is not difficult to fabricate the gate driver of the small size for reducing the cost. However, the size of the gate driver is limited by the pad layout of the gate driver. Hence, if the pad layout of the gate driver is optimized, the size of the gate driver can be effectively reduced and the wire layout of the display panel can be improved as well.

### SUMMARY OF THE INVENTION

It is therefore that an objective of the present invention to provide a display panel with optimum pad layout of the gate driver.

The present invention provides a display panel. The display panel comprises a display area, a first bonding area, and a second bonding area. The display area comprises a plurality of data lines and a plurality of scan lines. The first bonding area is electrically connected to the plurality of data lines for bonding with a source driver. The second bonding area is electrically connected to the plurality of scan lines for bonding with a gate driver. The second bonding area comprises a plurality of first pads, and a plurality of second pads. The plurality of the first pads is disposed on two sides of the second bonding area in a first direction, and on the two sides of the second bonding area only the plurality of the first pads is disposed in a second direction. The plurality of the second pads is disposed on a center region of the second bonding area in the first direction, and on the center region of the second bonding area only the plurality of the second pads is disposed in the second direction.

The present invention further provides a gate driver. The gate driver comprises a plurality of first pins, and a plurality of second pins. The plurality of the first pins is disposed on two sides of the gate driver in a first direction, and on the two sides of the gate driver only the plurality of the first pins is disposed in a second direction. The plurality of the second pins is disposed on a center region of the gate driver in the first direction, and on the center region of the gate driver only the plurality of the second pins is disposed in the second direction.

The present invention further provides a display panel. The display panel comprises a display area, and a bonding area. The display area comprises a plurality of scan lines. The bonding area is electrically connected to the plurality of scan lines for bonding with a gate driver. The bonding area comprises a plurality of first pads, and a plurality of second pads. The plurality of the first pads is disposed on two sides of the bonding area in a longitudinal axis direction. The plurality of the second pads is disposed on a center region of the bonding area in the longitudinal axis direction, and only the plurality of the second pads is arranged at the center region of the bonding area in a short axis direction substantially perpendicular to the longitudinal axis direction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional liquid crystal display (LCD).

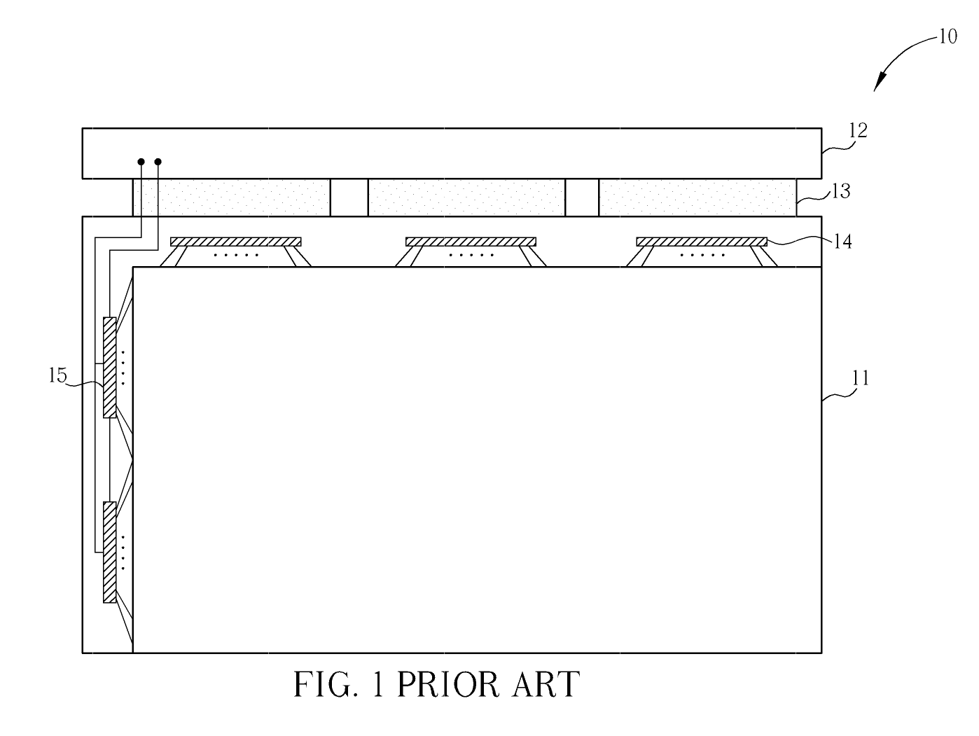

FIG. 2 is a diagram illustrating the pad layout for bonding with the gate driver.

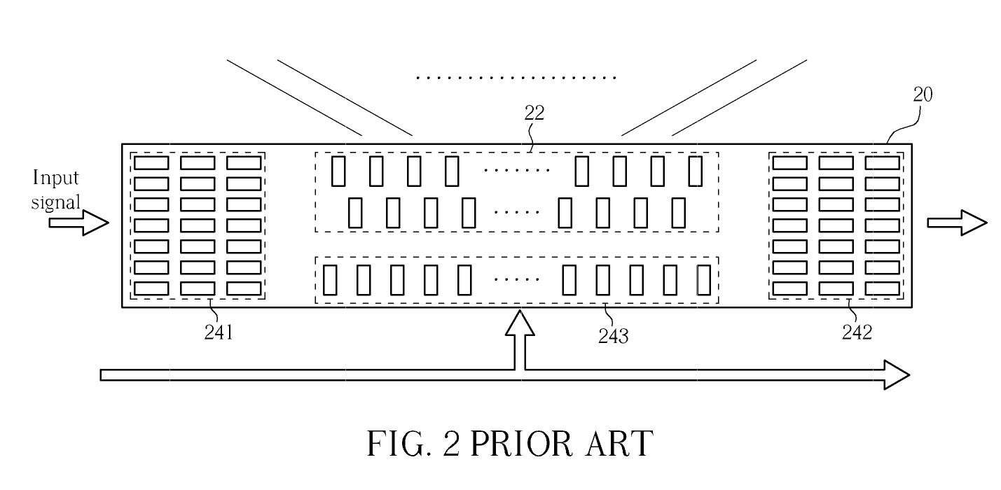

FIG. 3 is a diagram illustrating an LCD panel of the present invention.

FIG. 4A is a diagram illustrating the pad layout of the gate driver according to a first embodiment of the present invention.

FIG. 4B is a diagram illustrating the pin layout of the gate driver according to a first embodiment of the present invention.

FIG. 5 is a diagram illustrating the wiring layout corresponding to the output pads of FIG. 4A.

FIG. 6 is a diagram illustrating the pad layout of the gate driver according to a second embodiment of the present invention.

FIG. 7 is a diagram illustrating the wiring layout corresponding to the output pads of FIG. 6.

### DETAILED DESCRIPTION

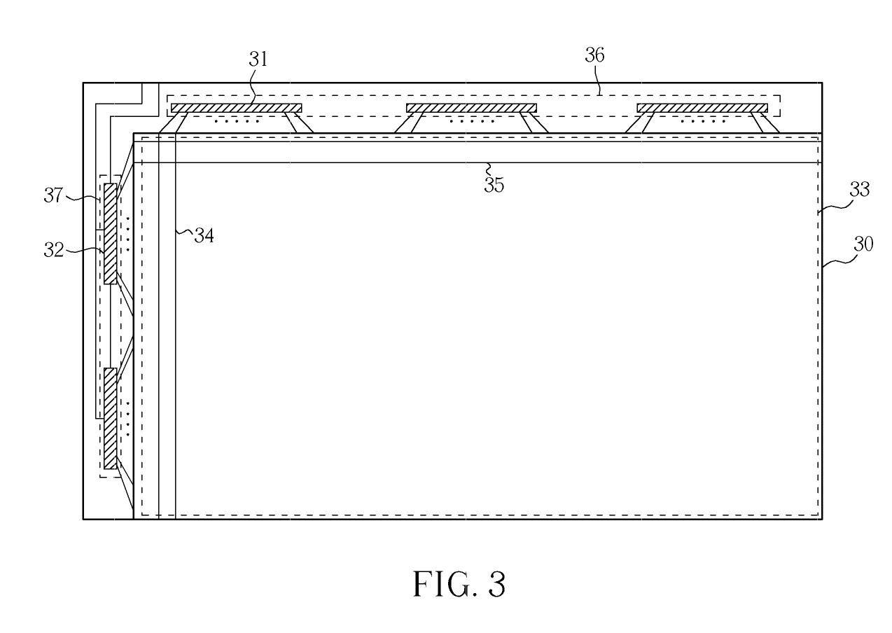

Please refer to FIG. 3. FIG. 3 is a diagram illustrating an LCD panel 30 of the present invention. The LCD panel 30 comprises a plurality of source drivers 31, a plurality of gate drivers 32, and a display area 33. The display area 33 comprises a plurality of data lines 34 and a plurality of scan lines 35. The source drivers 31 are disposed in a first bonding area 36 and electrically connected to the plurality of the data lines 34. The gate drivers 32 are disposed in the second bonding area 37 and electrically connected to the plurality of scan lines 35.

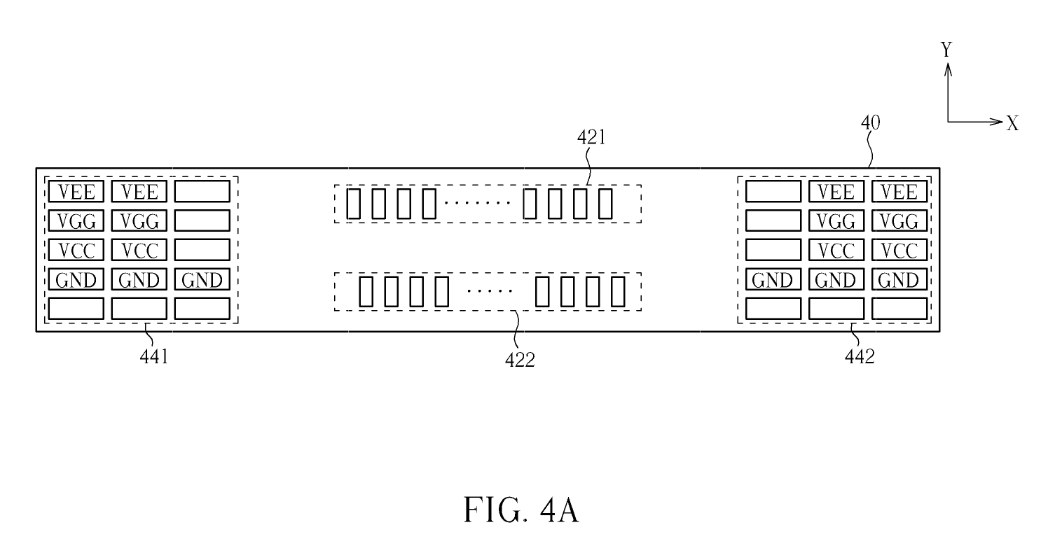

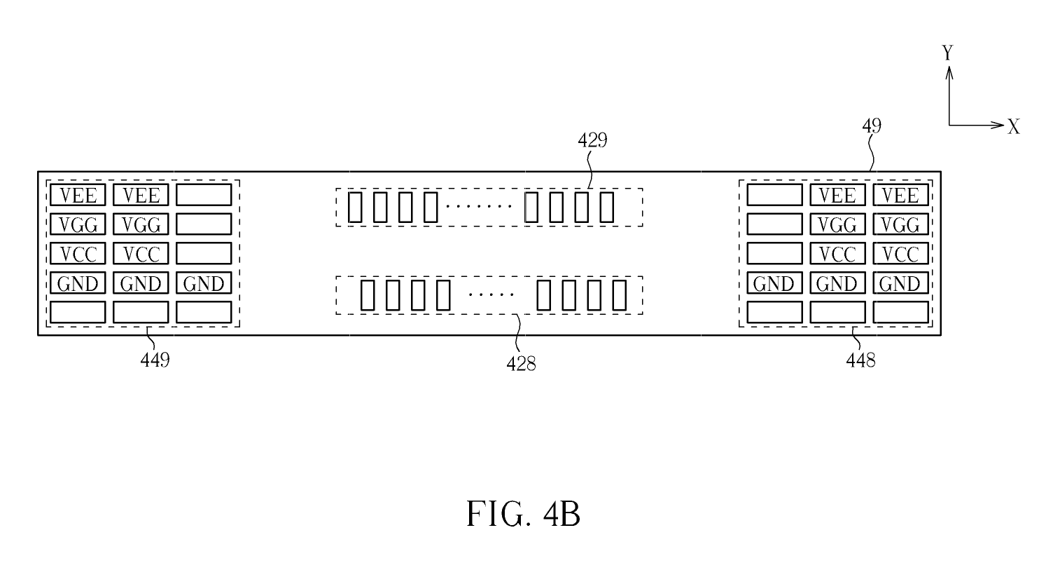

Please refer to FIG. 4A and FIG. 4B. FIG. 4A is a diagram illustrating the pad layout of the gate driver according to a first embodiment of the present invention. FIG. 4B is a diagram illustrating the pin layout of the gate driver according to a first embodiment of the present invention. In the second bonding area 37 of FIG. 3, the pad layout 40 of each gate driver 32 comprises a plurality of output pads 421 and 422, and a plurality of input pads 441 and 442. The input pads 441 and 442 respectively comprise a plurality of power voltage pads VCC, a plurality of gate high voltage pads VGG, a plurality of gate low voltage pads VEE, a plurality of ground voltage pads GND, and a plurality of control pads. The output pads 421 and 422 respectively comprise a plurality of odd pads 421 and a plurality of even pads 422. In Y direction, the odd pads 421 and the even pads 422 are not aligned with each other. In the pad layout 40 of the gate drivers 32 of the present invention, the repeating part of the input pads 441 and 442 is reduced, for example, the number of the power voltage pads VCC and the ground voltage pads GND can be reduced. Therefore the output pads 421 and 422, and the input pads 441 and 442 can be reallocated for reducing the width of the pad layout 40 so as to reduce the size of the gate driver 32.

In the pad layout 40 of the present invention, the input pads 441 and 442 are disposed on the two sides of the pad layout 40 in the first direction (X direction), and on the two sides of the pad layout 40, only the input pads 441 and 442 are disposed in the second direction (Y direction). The first direction (X direction) is substantially perpendicular to the second direction (Y direction). The output pads 421 and 422 are disposed on the center region in the X direction, and on the center region only the output pads 421 and 422 are disposed in the Y direction. In other words, in the X direction, the input pads 441 and 442 are disposed on the two sides, and the output pads 421 and 422 are disposed on the center region. In the Y direction, the output pads 421 and 422, and the input pads 441 and 442 do not coexist. The pad layout 40 represents the pads required for bonding a gate driver 32 to the display panel 30. Relatively, as shown in FIG. 4B, the gate driver 32 has to have the corresponding pins with the same layout as the abovementioned pads. The pin layout 49 of each gate driver 32 comprises a plurality of output pins 429 and 428, and a plurality of input pins 449 and 448. As a result, the input pins of the gate driver 32 are disposed on the two sides of the gate driver 32. The output pins of the gate driver 32 are disposed on the center region of the gate driver 32.

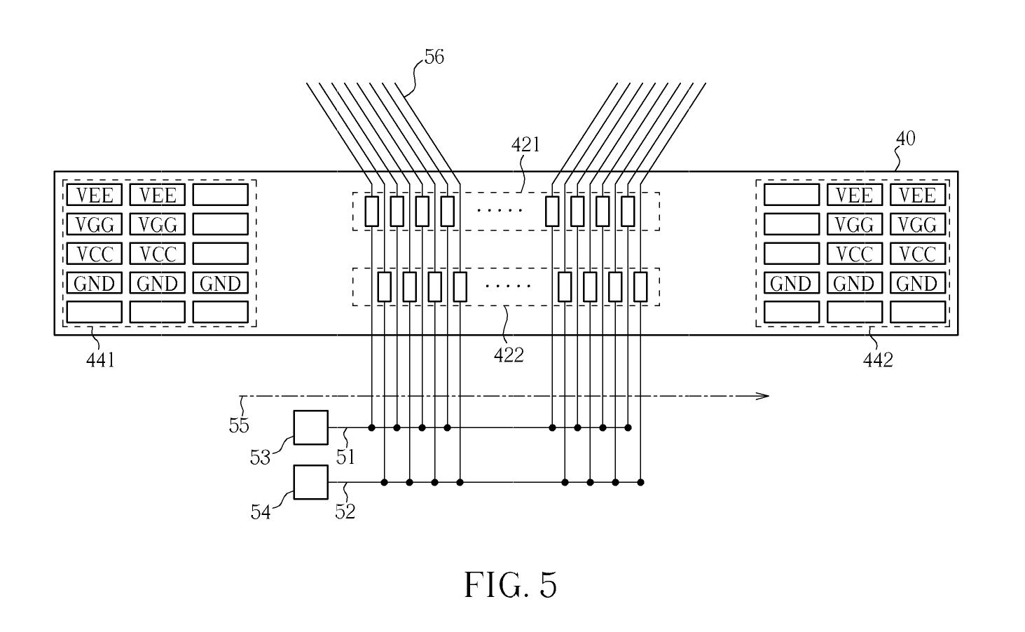

Please refer to FIG. 5. FIG. 5 is a diagram illustrating the wiring layout corresponding to the output pads of FIG. 4A. When the output pads 421 and 422, and the input pads 441 and 442 of the gate driver 32 are disposed according to the pad layout 40 of the present invention, on the center region of the gate driver 32 only the output pads 421 and 422 are disposed. In this way, the wires 56 on a first side (the upper side) of the gate driver 32 near the display area 33 are electrically connected to the scan lines 35 of the display area 33, and the test circuit of the display area 33 is disposed on the second side (the down side) of the gate driver 32. The test circuit comprises an odd shorting bar 51, an even shorting bar 52, an odd test pad 53, and an even test pad 54. The odd shorting bar 51 is electrically connected to all the odd pads 421. The even shorting bar 52 is electrically connected to all the even pads 422. The display panel 30 is inputted the test signals from the odd test pad 53 and the even test pad 54 during the testing phase. After the testing phase, the odd shorting bar 51 and the even shorting bar 52 can be removed by the laser cutting along the cutting line 55. Consequently, it is more convenient for the user to design the layout of the test circuit and the layout of the wires 56 electrically connected to the scan lines 35, according to the pad layout 40 of the present invention.

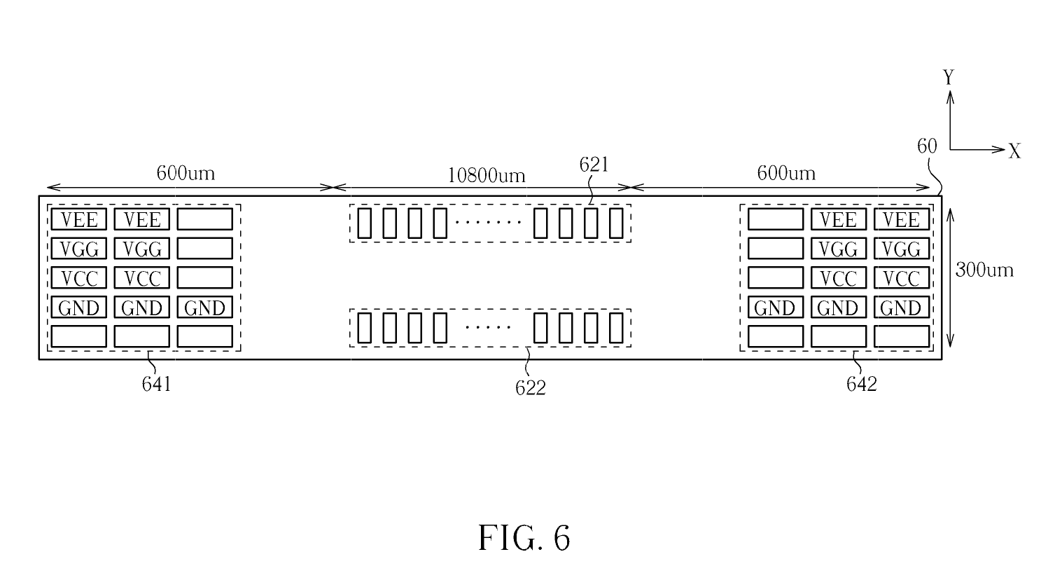

Please refer to FIG. 6. FIG. 6 is a diagram illustrating the pad layout of the gate driver according to a second embodiment of the present invention. In the second embodiment, the pad layout 60 of the gate driver 30 still disposes the output pads 621 and 622, and the input pads 641 and 642 in the same way. That is, in the X direction, the input pads 641 and 642 are disposed on the two sides and the output pads 621 and 622 are disposed on the central region. In the Y direction, the output pads 621 and 622, and input pad 641 and 642 do not coexist. The difference between the second embodiment and the first embodiment is that the odd pads 621 and the even pads 622 of the output pads 621 and 622 are aligned with each other. In this way, the consumed area of the pad layout 60 can be reduced. In the X direction, the total length of the input pads 641 is about 600 micrometers (um); the total length of the output pad 642 is about 300×36=10800 um; the total length of the input pads 642 is about 600 um; hence, the total length of the pad layout 60 is about 12000 um. In the Y direction, the total width of the input pads 642 is about 300 um. In the prior art, the total width of the input pads in the Y direction is about 600 um. Therefore, the pad layout of the present invention can effectively reduce the width of the pad layout in the Y direction so as to reduce the size of the gate driver.

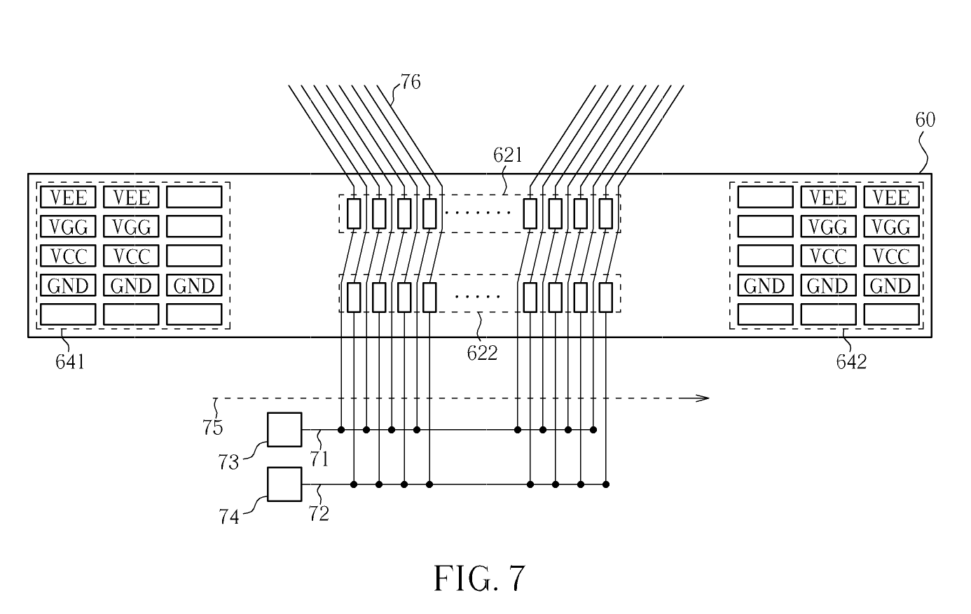

Please refer to FIG. 7. FIG. 7 is a diagram illustrating the wiring layout corresponding to the output pads of FIG. 6. Similarly, in the pad layout 60, the wires 76 on a first side (the upper side) of the gate driver 32 near the display area 33 are electrically connected to the scan lines 35 of the display area 33, and the odd shorting bar 71 and the even shorting bar 72 are disposed on the second side (the down side) of the gate driver 32. Since the odd pads 621 and the even pads 622 are aligned with each other, the wires 76 electrically connecting the even pads 622 to the scan lines 35 of the display area 33 have to bypass the odd pads 621, and the wires 76 electrically connecting the odd shorting bar 71 to the odd pads 621 have to bypass the even pads 622 as well. It is more convenient for the user to design the layout of the odd shorting bar 71 and the even shorting bar 72, according to the pad layout 60. Similarly, the display panel 30 can be inputted the test signals from the odd test pads 73 and the even test pads 74, and the odd test pads 73 and the even test pads 74 can be removed by the laser cutting along the cutting line 75 after the testing phase.

In conclusion, the present invention optimizes the pad layout of the gate driver for reducing the number of the pads of the gate driver, effectively reducing the size of the gate driver, and improving the wiring layout of the display panel. The display panel of the present invention comprises a display area, a first bonding area, and a second bonding area. The second bonding area is used for bonding with a gate driver. The second bonding area comprises a plurality of input pads and a plurality of output pads. The plurality of input pads is disposed on the two sides of the second bonding area in the first direction (longitudinal axis direction) and on the two sides of the second bonding area only the plurality of input pads is disposed in the second direction (short axis direction). The plurality of output pads is disposed on the center region of the second bonding area in the first direction and on the center region of the second bonding area only the plurality of output pads is disposed in the second direction. In addition, according to the pad layout of the second bonding area, the input pins of the gate driver of the present invention are disposed on the two sides of the gate driver in the first direction, and on the two sides of the gate driver only the input pins are disposed in the second direction. The output pins of the gate driver of the present invention are disposed on the center region of the gate driver in the first direction, and on the center region of the gate driver only the output pins are disposed in the second direction.

Those skilled in the art will readily observe that numerous modifications and alterations of the device and method may be made while retaining the teachings of the invention.

What is claimed is:

1. A display panel, comprising:
a display area, comprising a plurality of data lines and a plurality of scan lines;
a first bonding area, electrically connected to the plurality of data lines for bonding with a source driver; and
a second bonding area, electrically connected to the plurality of scan lines for bonding with a gate driver, the second bonding area comprising:
a plurality of first pads, disposed on two sides of the second bonding area in a first direction, and only the plurality of the first pads being disposed in a second direction; and
a plurality of second pads, disposed on a center region of the second bonding area in the first direction, and only the plurality of the second pads being disposed in the second direction.

2. The display panel of claim 1, wherein the second direction is substantially perpendicular to the first direction.

3. The display panel of claim 1, wherein the plurality of the first pads comprises a plurality input pads; the plurality of the second pads comprises a plurality output pads.

4. The display panel of claim 3, wherein the plurality of the input pads comprises a plurality of power voltage pads, a plurality of gate high voltage pads, a plurality of gate low voltage pads, a plurality of ground voltage pads, and a plurality of control pads.

5. The display panel of claim 3, wherein the plurality of the output pads comprises:
a plurality of odd pads, respectively electrically connected to odd scan lines of the plurality of the scan lines; and
a plurality of even pads, respectively electrically connected to even scan lines of the plurality of the scan lines.

6. The display panel of claim 5, further comprising:
an odd shorting bar, electrically connected to the plurality of the odd pads; and
an even shorting bar, electrically connected to the plurality of the even pads.

7. The display panel of claim 6, wherein the display area is disposed on a first side of the second bonding area; the odd shorting bar and the even shorting bar are disposed on a second side different from the first side.

8. A gate driver, comprising:
a plurality of first pins, disposed on two sides of the gate driver in a first direction, and only the plurality of the first pins being disposed in a second direction; and
a plurality of second pins, disposed on a center region of the gate driver in the first direction, and only the plurality of the second pins being disposed in the second direction.

9. The gate driver of claim 8, wherein the second direction is perpendicular with the first direction.

10. The gate driver of claim 8, wherein the plurality of the first pins comprises a plurality input pins; the plurality of the second pins comprises a plurality output pins.

11. The gate driver of claim 10, wherein the plurality of the input pins comprises a plurality of power voltage pins, a plurality of gate high voltage pins, a plurality of gate low voltage pins, a plurality of ground voltage pins, and a plurality of control pins.

12. The gate driver of claim 10, wherein the plurality of the output pins comprises a plurality of odd pins and a plurality of even pins.

13. A display panel, comprising:
a display area, comprising a plurality of scan lines; and
a bonding area, electrically connected to the plurality of scan lines for bonding with a gate driver, the bonding area comprising:
a plurality of first pads, disposed on two sides of the bonding area in a longitudinal axis direction; and
a plurality of second pads, disposed on a center region of the bonding area in the longitudinal axis direction, and only the plurality of the second pads being arranged at the center region of the bonding area in a short axis direction substantially perpendicular to the longitudinal axis direction.

14. The display panel of claim 13, wherein the plurality of the first pads comprises a plurality input pads; and the plurality of the second pads comprises a plurality output pads.

15. The display panel of claim 14, wherein the plurality of the input pads comprises a plurality of power voltage pads, a plurality of gate high voltage pads, a plurality of gate low voltage pads, a plurality of ground voltage pads, and a plurality of control pads.

16. The display panel of claim 14, wherein the plurality of the output pads comprises:
a plurality of odd pads, respectively electrically connected to odd scan lines of the plurality of the scan lines; and
a plurality of even pads, respectively electrically connected to even scan lines of the plurality of the scan lines.

17. The display panel of claim 16, wherein the plurality of the odd pads and the plurality of even pads are aligned with each other.

18. The display panel of claim 13, wherein the gate driver comprises:
a plurality of first pins, disposed on two sides of the gate driver in the longitudinal axis direction for respectively contacting with the plurality of first pads; and
a plurality of second pins, disposed on a center region of the gate driver in the longitudinal axis direction for respectively contacting with the plurality of second pads, and only the plurality of the second pins being arranged in the short axis direction.
